(19) United States
(12) Patent Application Publication
(10) Pub. No.: US 2006/0074893 A1
(43) Pub. Date: Apr. 6, 2006

(54) Unit for and method of detection a content property in a sequence of video images

(75) Inventors: Freddy Snijder, Eindhoven (NL); Igor Wilhelmus Franciscus Paulussen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/525,171

(22) PCT Filed: Jul. 31, 2003
(86) PCT No.: PCT/IB03/03401

§ 371 Date: Feb. 22, 2005

(30) Foreign Application Priority Data
Aug. 26, 2002 (EP) 02078516.8

(51) Int. Cl. G06F 17/30

(52) U.S. Cl. 707/4

(57) ABSTRACT

A method of detection of a content property in a data stream on basis of low-level features is proposed. The method comprises: determining (202) a behavior feature (e.g. 320) from a sequence of the low-level features; determining (204) to which one of the predetermined clusters (304) of behavior features (318-328) within a behavior feature space (300) the determined behavior feature (320) belongs; determining a confidence level of the content property presence on basis of the determined cluster (304) of behavior features and the determined behavior feature; and detecting the content property on basis of the confidence level of the content property presence.

The invention relates to a method of detection of a content property in a data stream on basis of low-level features.

The invention further relates to a unit for detection of a content property in a data stream on basis of low-level features.

The invention further relates to an image processing apparatus comprising such a unit.

The invention further relates to an audio processing apparatus comprising such a unit.

The amount of video information that can be accessed and consumed from people's living rooms has been ever increasing. This trend may be further accelerated due to the convergence of both technology and functionality provided by future television receivers and personal computers. To obtain the video information that is of interest, tools are needed to help users extract relevant video information and to effectively navigate through the large amount of available video information. Existing content-based video indexing and retrieval methods do not provide the tools called for in the above applications. Most of those methods may be classified into the following three categories: 1) syntactic structurization of video; 2) video classification; and 3) extraction of semantics.

The work in the first category has concentrated on shot boundary detection and key frame extraction, shot clustering, table of content creation, video summarization and video skimming. These methods are in general computationally simple and their performance is relatively robust. Their results, however, may not necessarily be semantically meaningful or relevant. For consumer-oriented applications, semantically irrelevant results may distract the user and lead to frustrating search or browsing experience.

The work in the second category, i.e. video classification, tries to classify video sequences into categories such as news, sports, action movies, close-ups, crowd, etc. These methods provide classification results which may facilitate users to browse video sequences at a coarse level. Video-content analysis at a finer level is probably needed to more effectively help users find what they are looking for. In fact, consumers often express their search items in terms of more exact semantic labels, such as keywords describing objects, actions, and events.

Work in the third category, i.e. extraction of semantics has been mostly specific to particular domains. For example, methods have been proposed to detect events in: football games, soccer games, basketball games, baseball games, and sites under surveillance. Advantages of these methods are that the detected events are semantically meaningful and usually significant to users. A disadvantage, however, is that many of these methods are heavily dependent on specific artifacts such as editing patterns in the broadcast programs, which makes them difficult to extend for the detection of other events.

An embodiment of the method of the kind described in the opening paragraph is known from the article “A Semantic Event-Detection Approach and Its Application to Detecting Hunts in Wildlife Video” by Niels Haering, Richard J. Qian, and M. Ibrahim Sezan, in IEEE Transactions on Circuits and systems for Video Technology, Vol. 10, No. 6, September 2000. In that article a computational method and several algorithmic components toward an extensible solution to semantic event detection are proposed. The automated event-detection algorithm facilitates the detection of semantically significant events in the video content and helps to generate semantically meaningful highlights for fast browsing. It is an extensible computational approach which is adapted to detect different events in different domains. A three-level video event-detection algorithm is proposed. The first level extracts low-level features from the video images like color, texture, and motion features.

It is an object of the invention to provide a method of the kind described in the opening paragraph which is relatively robust.

This object of the invention is achieved in that the method comprises:
determining a behavior feature from a sequence of the low-level features;
determining to which cluster from a set of predetermined clusters of behavior features within a behavior feature space the determined behavior feature belongs;
determining a confidence level of a content property presence on basis of the determined behavior feature and the determined cluster; and
detecting the content property on basis of the determined confidence level of the content property presence.
   A problem with applying low-level features for detecting a content property is that the variation of the low-level features is relatively high. By means of extracting behavior features from a sequence of low-level features and by determining a confidence level on basis of a determined cluster and the behavior feature the variance is decreased without loss of relevant information. An advantage of the method is that it is a generic approach for detecting different content properties at different time scales, e.g. events like scene changes but also genres.

The data stream might correspond to a series of video images or to audio data. Low-level features provide very rough information about the content and have low information density in time. Low level features are based on simple operations on samples of the data stream, e.g. on pixel values in the case of images. The operations might include addition, subtraction and multiplications. Low level features are, for instance, features like average frame luminance, luminance variance in a frame, average Mean Absolute Difference (MAD). For instance high MAD values can indicate a lot of motion or action in the content whereas high luminance can tell something about the type of content. For instance commercials and cartoons have high luminance values. Alternatively low-level features correspond with parameters derived from of a motion estimation process, e.g. the size of motion vectors or with parameters derived from a decoding process, e.g. DCT coefficients.

Behavior features are related to the behavior of low-level features. That means that e.g. the values of a low-level feature as function of time are comprised by a behavior feature. A value of behavior feature is calculated by means of combining multiple values of a low-level feature.

In an embodiment of the method according to the invention the determined behavior feature comprises a first mean of values of a first one of the low-level features in the sequence. That means that the average value is calculated for the first one of the low-level features in a time window of the sequence. Calculating an average value is relatively easy. Another advantage is that calculating the average value is a good measure to reduce the variance. Alternative approaches for extracting behavior features from low-level features are as follows:

calculating the standard deviation of the low-level feature in the window;

taking the N most important power spectrum values of the Fourier Transform of the low-level feature in the window;

taking the N most important Principal Components in the window. See Christopher M. Bishop, “Neural Networks for Pattern Recognition”, Oxford university press, 1995. See also T. Kohonen, “Self-Organizing Maps”, Springer, 2001, ISBN 3-540-67921-9.

Applying the frequency and/or intensity of low-level events such as scene changes or black frames in the window.

Preferably the determined behavior feature comprises a second mean of values of a second one of the low-level features in the sequence. In that case the behavior feature is a vector comprising multiple elements, each related to respective low-level features. Alternatively, a behavior feature comprises multiple elements, each related to one low-level feature, e.g. the mean and the standard deviation of the luminance. Looking at one low-level feature or at multiple low-level features separately will most likely not provide enough information about the genre type or the type of event occurring, however, looking at the combinatorial behavior of multiple low-level features together provides much more information and gives much more discriminative power.

In an embodiment of the method according to the invention the confidence level of the content property presence is determined on basis of a model of the determined cluster of behavior features. Preferably the model is a linear model since it is simple and robust. During a design phase numerous instances of behavior features have been determined for test data. This test data might for instance be hours of annotated video images. Annotation means that for each of these video images it was known and indicated whether the images have the content property or not. E.g. whether the images are of a particular genre or not. By segmentation of the distribution of the behavior features of the test data a number of predetermined clusters have been established. For each of these predetermined clusters a model and a cluster center has been calculated. During detection phase, i.e. when applying the method according to the invention, the appropriate cluster is determined for the particular behavior feature. Depending on the used clustering method this could be done by calculating the Euclidean distances between the particular behavior feature and the various cluster centra. The minimum Euclidean distance leads to the predetermined cluster to which the particular behavior feature belongs. By evaluation of the model of the appropriate predetermined cluster for the particular behavior feature the corresponding confidence level is determined. This confidence level is related to the fit of the model of the predetermined cluster for the particular behavior feature with the used annotation data during the model design phase. Or in other words, it is a measure of the probability that the particular behavior feature actually corresponds to the content property.

Alternatively the confidence level of the content property presence is determined with a neural network.

In an embodiment of the method according to the invention detecting the content property is done by comparing the confidence level of the content property presence with a predetermined threshold. E.g. if the confidence level of the content property presence is higher than the predetermined threshold then it is a assumed that the data stream comprises the content property. An advantage of using a threshold is that it is relatively easy.

An embodiment of the method according to the invention further comprises outlier filtering by means of comparing the confidence level of the content property presence with a further confidence level corresponding to a further behavior feature. Optionally multiple behavior features are applied to determine whether the confidence level is a correct indication that the content property is actually comprised by the data stream. Preferably the confidence levels corresponding to multiple behavior features in a time window around the particular behavior feature are used for the outlier filtering. An advantage of this embodiment according to the invention is that it is relatively robust and simple.

An embodiment of the method according to the invention further comprises determining which of the video images corresponds to a part of the series of video images having the content property. By extracting behavior features from a sequence of low-level features, e.g. by averaging, a time shift is introduced in the detection of the content property and the actual start of the part of the series of video images having that content property. For example it is detected that a series of video images comprises a part of a cartoon and another part which does not belongs to a cartoon. The actual transition from cartoon to non-cartoon is determined on basis of the instance of the behavior feature which lead to the detection of cartoon in the series of video images and on basis of time related parameters, e.g. the size of a window used to extract the behavior features from the low-level features.

In an embodiment of the method according to the invention data from an EPG is applied for the detection of the content property. Higher level data like from an Electronic Program Guide is very appropriate to increase the robustness of the method of detection the content property. It gives context to the detection problem. Making a detector to detect football matches is easier when this detector is confined to video streams of sport programs indicated by the EPG.

An embodiment of the method according to the invention further comprises:
determining to which further cluster from the set of predetermined clusters of behavior features within the behavior feature space the determined behavior feature belongs;
determining a further confidence level of a further content property presence on basis of the determined behavior feature and the further determined cluster; and
detecting a further content property on basis of the further determined confidence level of the further content property presence.
   An advantage of this embodiment according to the invention is that a further content property can be detected with relatively few additional effort. The most expensive calculations, e.g. for calculating low-level features and for extracting behavior features are shared. Only the relatively simple processing steps are specific for the additional detection of the further content property. With this embodiment it is e.g. possible to detect whether a sequence of video images corresponds to a cartoon and whether the sequence of video images corresponds to a wild-life movie.

It is a further object of the invention to provide a unit of the kind described in the opening paragraph which is designed to perform a relatively robust detection.

This object of the invention is achieved in that the unit comprises:

first determining means for determining a behavior feature from a sequence of the low-level features;

second determining means for determining to which cluster from a set of predetermined clusters of behavior features within a behavior feature space the determined behavior feature belongs;

third determining means for determining a confidence level of a content property presence on basis of the determined behavior feature and the determined cluster; and

detecting means for detecting the content property on basis of the determined confidence level of the content property presence.

It is advantageous to apply an embodiment of the unit according to the invention in an image processing apparatus as described in the opening paragraph. The image processing apparatus may comprise additional components, e.g. a display device for displaying images, a storage device for storage of images or an image compression device for video compression, i.e. encoding or decoding, e.g. according to the MPEG standard or H26L standard. The image processing apparatus might support one of the following applications:

Retrieval of recorded data based on genre or event information;

Automatic recording of data based on genre and event information;

Hopping between stored data streams with the same genre, during playback;

Hopping from event to event of the same type, during playback, for instance hopping form football goal to football goal;

Alerting a user if a certain genre is broadcasted on a different channel. For instance a user can be looking at one channel and is alerted that a football match starts at another channel;

Alerting a user if a specific event has happened. For instance a user is watching one channel but is alerted that a football goal has happened on another channel. The user could switch to the other channel and watch the goal.

Notifying a security officer that something happened in a room that is monitored with a video camera.

Modifications of the method and variations thereof may correspond to modifications and variations thereof of the unit described.

These and other aspects of the method, of the unit and of the image processing apparatus according to the invention will become apparent from and will be elucidated with respect to the implementations and embodiments described hereinafter and with reference to the accompanying drawings, wherein:

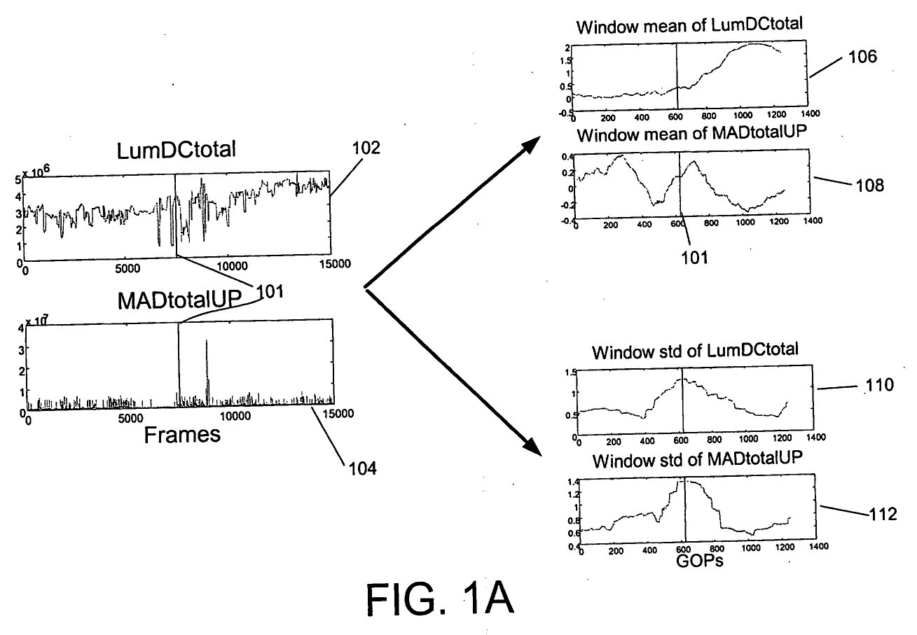

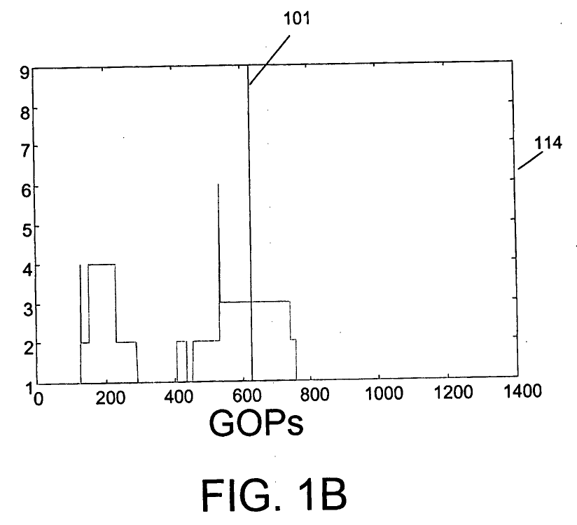

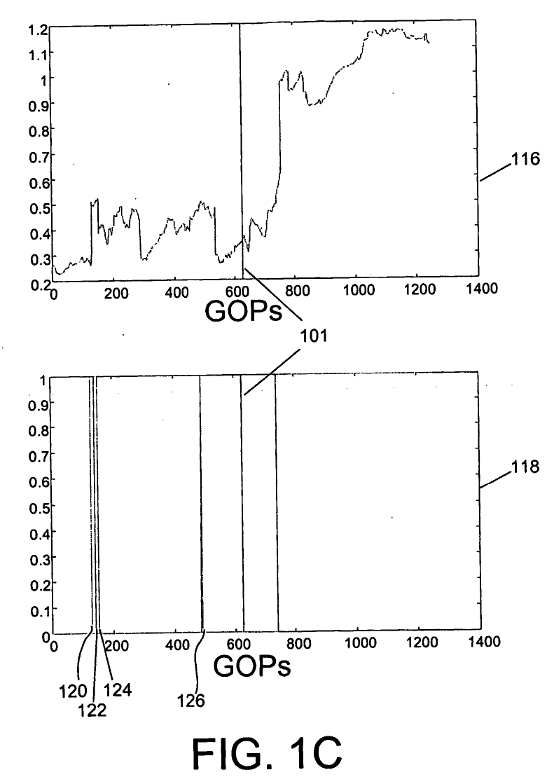

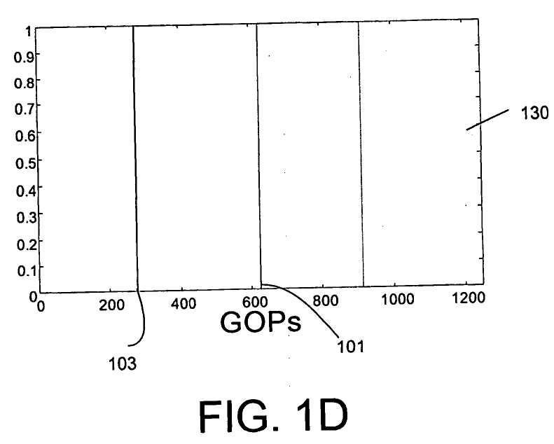

FIG. 1A shows examples of low-level features and behavior features extracted from these low-level features;

FIG. 1B shows an example of the best matching clusters for the behavior feature vectors from FIG. 1A;

FIG. 1C shows the confidence level being determined on basis of the behavior feature vectors of FIG. 1A and the best matching clusters in FIG. 1B;

FIG. 1D shows the final output after thresholding the confidence levels of FIG. 1C and outlier removal;

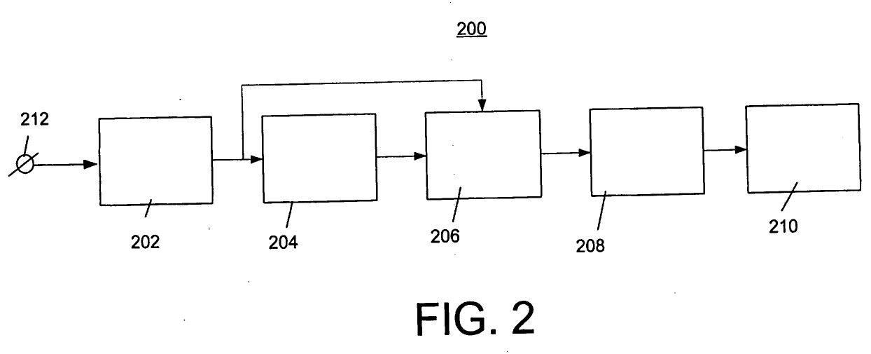

FIG. 2 schematically shows a unit for detecting a content property in a data stream;

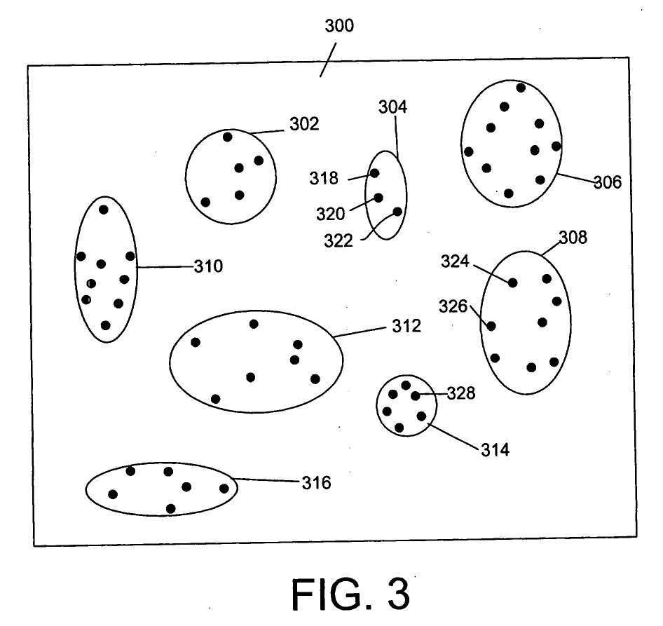

FIG. 3 schematically shows a behavior feature space comprising a number of clusters of behavior feature vectors;

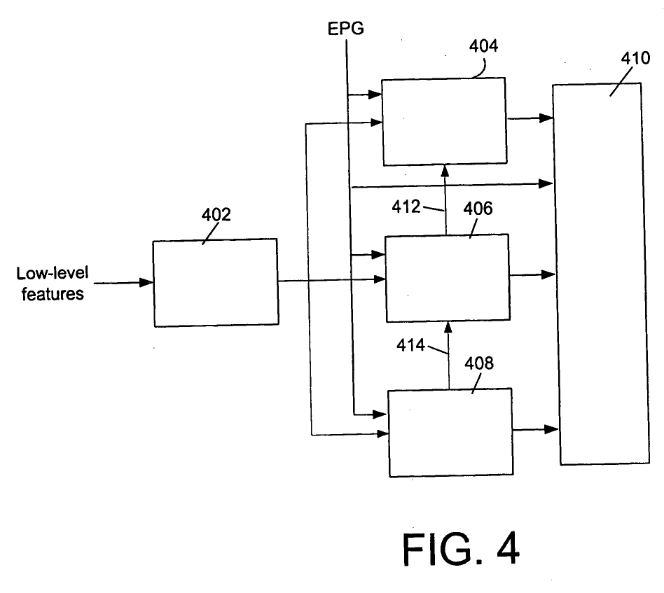

FIG. 4 schematically shows a block-diagram of a content analyzing process based on low-level features; and

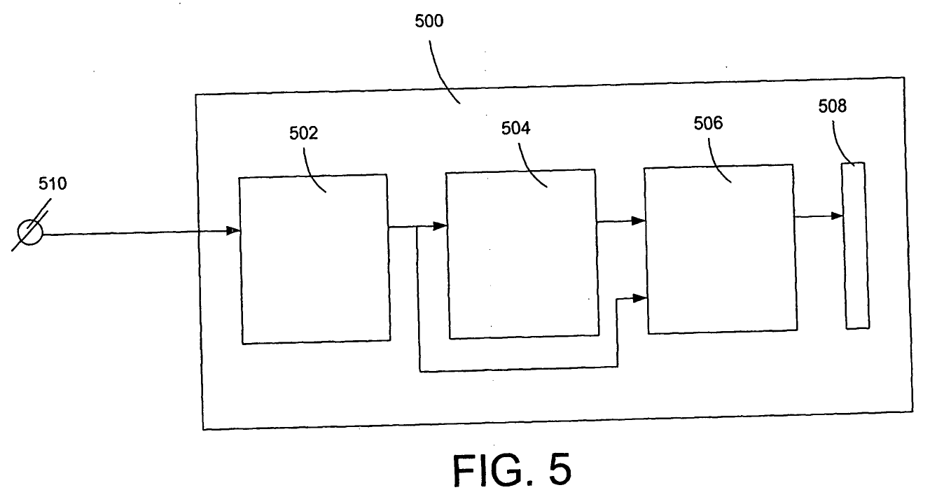

FIG. 5 schematically shows elements of an image processing apparatus according to the invention.

Same reference numerals are used to denote similar parts throughout the figures.

By means of an example the method according to the invention will be explained below. The example concerns cartoon detection. In FIGS. 1A-1D some curves belonging to the example are depicted. The low-level features used for the cartoon detection are extracted from an MPEG2 encoder. The GOP (Group Of Pictures) length used for encoding was 12. Some features are only available every I-frame other are available every frame. See Table 1 for an overview of the used low-level AV features. In this example, no audio features were used but only video features.

TABLE 1
Examples of Low-level features.

| Low-level feature | Description | Discriminatory power |
|---|---|---|
| LumDCtotal | Average image luminance | Brightness is important so this |
| | | feature will be of interest. Cartoons |
| | | are typically bright |
| LumDCLetterbox | Average luminance in | When a letterbox is present the |
| | letterbox area | overall luminance is lower. This |
| | | feature can correct this problem. |
| LumDCDiff | Average luminance | The average luminance difference |
| | difference in frame | gives information on the non- |
| | | uniformity of the image. The more |
| | | structure in the image due to objects, |
| | | persons and other phenomena, the |
| | | higher the lumDCDiff. This feature |
| | | can thus give information about the |
| | | information richness of the image |
| LumDCDiffLetter | Average luminance | If LumDCDiff is low because there |
| | difference in letterbox area | are letterboxes present this feature |
| | | can correct for it. In case of cartoons |
| | | at the letterbox positions typically |
| | | not much is drawn. |
| MADtotalUP | Sum MAD of upper image | high MAD error implies that |
| | part | consecutive frames are not alike. |
| | | This could be due to heavy motion or |
| | | a shot break. Since it gives |
| | | information about movement. |
| MADtotalLMP | Sum MAD of middle and | See MADtotalUP |
| | lower image part | |
| Complexity | Mulitiplication of current | This features gives information about |
| | quantizing scale and | the combination of motion in the |
| | bitrate | sequence and the complexity of the |
| | | image itself at the current frame. In |
| | | many cases cartoons have much |
| | | motion and have complex images |
| | | (due to hard edges etc.) |
| xMotionAverageUP | Average horizontal motion | Gives information about the amount |
| | calculated in the upper | of motion in the image |
| | image part | |
| xMotionAverageLMP | Average horizontal motion | See xMotionAverageUP |
| | calculated in middle and | |
| | lower image part | |
| yMotionAverageUP | Average vertical motion | See xMotionAverageUP |
| | calculated in upper | |
| | image part | |
| YMotionAverageLMP | Average vertical motion | See xMotionAverageUP |
| | calculated in middle | |
| | and lower image part | |

FIG. 1A shows examples of low-level features and behavior features extracted from these low-level features. FIG. 1A shows the MAD for every frame 104 and the total frame luminance 102 for every I-frame of an example part of the data stream. The data stream corresponds with six minutes of video images and contains the transition form non-cartoon to cartoon material. The position of the transition is marked with the vertical line 101. As behavior features the mean 106, 108 and standard deviation 110, 112 of the low-level features 102, 104 over a time window are calculated. Before the mean and standard deviation are calculated the low-level features are normalized. The calculated mean values and standard deviation values are stacked in a vector to form a behavior feature vector. Every GOP the window is shifted and a new behavior feature vector is calculated. The used window length is 250 GOP's, which is approximately two minutes. Averaging the frame based statistics in a GOP gives more robust features. For instance the MAD has a very large dynamic range: when a shot cut occurs the value can be orders of magnitude higher then when there is not much movement in the content. In the design phase the behavior feature vector space has been segmented into clusters using a Self-Organizing Map. See T. Kohonen, “Self-Organizing Maps”, Springer, 2001, ISBN 3-540-67921-9. The self-organizing map is able to cluster the behavior feature space such that it forms a good representation of the behavior feature vector distribution in the behavior feature space. The clusters of the SOM are spatially organized in a map, in our case the map consists of a 3×3 map of units containing the clusters. In this example the spatial organization property is not used but could further improve detection quality since the position on the map provides information. In other words there are 9 predetermined clusters. During the design phase, for every cluster in the SOM a local linear classification model was made too.

In the detection phase for each behavior feature vector the appropriate cluster is determined. That means that the SOM is evaluated using the behavior feature vector. The evaluation results in a cluster index indicating the cluster that best matches the behavior feature vector. FIG. 1B shows the cluster indices that best match the behavior feature vectors of the example data stream.

In the detection phase the model that belongs to the selected cluster is evaluated using the behavior feature vector. Each evaluation results in a confidence level, i.e. “cartoon-ness confidence”. FIG. 1C shows the “cartoon-ness confidence” for each GOP 116 for the example data, i.e. FIG. 1C shows the confidence level being determined on basis of the behavior feature vectors of FIG. 1A and the cluster indices of FIG. 1B. Note that the confidence level shown is not necessarily the confidence in the strict probabilistic sense, since the values are not in the range between 0 and 1.

To resume: every GOP a new behavior feature vector is calculated and the cluster index is found that best matches this behavior feature vector. Thus every GOP only one local linear model is evaluated on the calculated behavior feature vector.

By means of thresholding the content property is detected, i.e. by means of comparing the confidence level with a predetermined threshold is detected that the data stream comprises images belonging to a cartoon. The predetermined threshold has been determined during the design phase. The lower part of FIG. 1C shows the output 118 of the thresholding. The output 118 is 1 if the “cartoon-ness confidence” is equal to or higher than the predetermined threshold and the output is 0 if the “cartoon-ness confidence” is less than the predetermined threshold.

In the output 118 of the thresholding there are some outliers 120-126. That means that there are spikes in the output 118. By means of filtering these outliers 120-126 are removed. This filtering works as follows. Within a time window it is calculated what percentage of the classifications as determined by means of the thresholding is positive (i.e. “1”). If the percentage is higher than a second predetermined threshold the decision is made that a cartoon is present, else it is decided that no cartoon is present. The outlier removal window length and the second predetermined threshold have been calculated during the design phase.

After having determined that a cartoon is present in the video sequence being represented by the data stream it might be required to determine a beginning and an end of the cartoon. By taking into account the lengths of the various time windows, e.g. for extracting the behavior features and outlier removal, a worst-case beginning and end can be calculated. The worst-case beginning 103 and end are such that there is a very high certainty that the complete cartoon is within this beginning 103 and end. This is of interest because the user of the image processing apparatus according to the invention should not be annoyed by starting play back of the detected cartoon after the cartoon has already started or stopping the play back before the cartoon has finished. The calculated worst-case beginning 103 in the example data stream is depicted in FIG. 1D.

FIG. 2 schematically shows a unit 200 for detecting a content property in a data stream on basis of low-level features. The unit 200 comprises:

An extracting unit 202 for extracting behavior features 106-112 from sequences of low-level features 102, 104 which are provided at the input connector 212. The low-level features might be calculated on basis of a video or audio data. Behavior features might be scalars or vectors;

A first determining unit 204 for determining to which of the predetermined clusters 302-316 of behavior features 318-328 within a behavior feature space 300 the behavior features belong. See also FIG. 1B and FIG. 3;

A second determining unit 206 for determining confidence levels of the respective behavior features on basis of the selected clusters 302-316 of behavior features 318-328. See also FIG. 1C and FIG. 3;

A classification unit 208 for detecting the content property on basis of the confidence levels of the behavior features. Optionally this classification unit 208 comprises an outlier removal filter as described in connection with FIG. 1D; and

A beginning and end calculating unit 210 for calculating the beginning of a part of the sequence having the content property. This beginning calculating unit 210 is as described in connection with FIG. 1D. This beginning calculating unit 210 is optional. The extracting unit 202, the first determining unit 204, the second determining unit 206, the classification unit 208 and the beginning and end calculating unit 210 of the unit 200 for detecting a content property may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

The method provides a design template for hardware detection units, in every unit the components are the same but the design parameters are different.

FIG. 3 schematically shows a behavior feature space 300 comprising a number of clusters 302-316 of behavior feature vectors 318-328. The behavior feature space 300 as depicted in FIG. 3 is a multi-dimensional space. Each of the axes of the behavior feature space 300 corresponds to respective elements of the behavior feature vectors 318-328. Each cluster 302-316 within the behavior feature space 300 can be interpreted as a mode of the content. For instance in the case that the content property corresponds to “cartoon in a sequence of video images”, a first cluster 302 might correspond with a first mode of a cartoon with fast moving characters. The cluster are, in principal, independent of a specific content property; one cluster could indicate fast moving material with varying luminance. Then the relation presented by a local model could state that the feature vectors with low luminance are not cartoon, however vectors with high luminance are cartoons. In other clusters another relation may exist (described by the local model belonging to that cluster) A second cluster 316 might correspond to a second mode of a cartoon with slow moving characters and a third cluster 306 might correspond to a cartoon scene in the evening.

For each of the clusters 302-316 a model is determined during the design phase. That might be a linear model being determined by means of solving a set of equations with a least square method. For one instance of a behavior feature vector \overline{x} with N elements the equation for a linear model Mᵢ is given in Equation 1:

$${M}_{i} \text{:} y = {\sum }_{k = 1}^{N} {α}_{k} {x}_{k} + {β}_{i} \qquad ( 1 )$$

During the design phase the N values of the parameters αₖ (with 1≦k≦N) and the N values of the parameter βᵢ have to be determined. During the design phase the value of y is 0 if the particular behavior feature vector of the test data corresponds to a part of the data, e.g. a video image, which does not have the content property and the value of y is 1 if the particular behavior feature vector of the test data corresponds to a part of the data which has the content property.

In the detection phase the value of y corresponds with the confidence level for a particular behavior feature vector of the target data. This latter value of y is easily found by means of evaluating Equation 1 for a particular behavior feature vector of the target data with the known values of the parameters αₖ (with 1≦k≦N) and the parameter βᵢ.

FIG. 4 schematically shows a block-diagram of a content analyzing process based on low-level features which are calculated for a data stream. The low-level features are input for the extraction 402 of behavior features. These behavior features are used for multiple decision processes 404-408. E.g. to detect whether the data stream which represents a video sequence comprises a cartoon 404, or comprises a commercial 406 or comprises a sports game 408. Optionally information from an EPG corresponding to the data stream or statistical data derived from EPG information of related data streams is applied to analyze the data stream.

Optionally intermediate results 414 from a first decision processes 408 are provided to a second decision process 406 and results 412 from the second decision process 306 are provided to a third decision process 404. These decision processes 404-408 might correspond to different time scales, i.e. from short-term with e.g. scene changes and commercial separators, to mid-term with e.g. high lights, video clips, similar content to long-term with e.g. genre recognition and user preference recognition. Optionally the final results of the decision processes 404-408 are combined 410. In principal, for example, info from 408 could also go to 404 directly.

FIG. 5 schematically shows elements of an image processing apparatus 500 according to the invention, comprising:

a receiving unit 502 for receiving a data stream representing images to be displayed after some processing has been performed. The signal may be a broadcast signal received via an antenna or cable but may also be a signal from a storage device like a VCR (Video Cassette Recorder) or Digital Versatile Disk (DVD). The signal is provided at the input connector 510.

a unit 504 for detecting a content property in the data stream on basis of low-level features as described in connection with FIGS. 1A-1D;

an image processing unit 506 being controlled by the unit 504 for detecting a content property on basis of the content property. This image processing unit 506 might be arranged to perform noise reduction. E.g. in the case that the unit 504 has detected that the data stream corresponds to a cartoon the amount of noise reduction is increased; and

a display device 508 for displaying the processed images. This display device 508 is optional.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. Method of detection of a content property in a data stream on basis of low-level features, the method comprising:
determining a behavior feature from a sequence of the low-level features;
determining to which cluster from a set of predetermined clusters of behavior features within a behavior feature space the determined behavior feature belongs;
determining a confidence level of a content property presence on basis of the determined behavior feature and the determined cluster; and
detecting the content property on basis of the determined confidence level of the content property presence.

2. Method of detection of a content property as claimed in claim 1, wherein the data stream corresponds to a series of video images.

3. Method of detection of a content property as claimed in claim 1, wherein the determined behavior feature comprises a first mean of values of a first one of the low-level features in the sequence.

4. Method of detection of a content property as claimed in claim 3, wherein the determined behavior feature comprises a second mean of values of a second one of the low-level features in the sequence.

5. Method of detection of a content property as claimed in claim 1, wherein the confidence level of the content property presence is determined on basis of a model of the determined cluster of behavior features.

6. Method of detection of a content property as claimed in claim 5, wherein the model of the determined cluster of behavior features is a linear model.

7. Method of detection of a content property as claimed in claim 1, wherein the confidence level of the content property presence is determined with a neural network.

8. Method of detection of a content property as claimed in claim 1, wherein detecting the content property is done by comparing the confidence level of the content property presence with a predetermined threshold.

9. Method of detection of a content property as claimed in claim 1, further comprising outlier filtering by means of comparing the confidence level of the content property presence with a further confidence level corresponding to a further behavior feature.

10. Method of detection of a content property as claimed in claim 2, further comprising determining which of the video images corresponds to a part of the series of video images having the content property.

11. Method of detection of a content property as claimed in claim 1, wherein data from an EPG is applied for the detection of the content property.

12. Method of detection of a content property as claimed in claim 1, further comprising:
determining to which further cluster from the set of predetermined clusters of behavior features within the behavior feature space (300) the determined behavior feature belongs;
determining a further confidence level of a further content property presence on basis of the determined behavior feature and the further determined cluster; and
detecting a further content property on basis of the further determined confidence level of the further content property presence.

13. A unit for detecting a content property in a data stream on basis of low-level features, the unit comprising:
first determining means for determining a behavior feature from a sequence of the low-level features;
second determining means for determining to which cluster from a set of predetermined clusters of behavior features within a behavior feature space the determined behavior feature belongs;
third determining means for determining a confidence level of a content property presence on basis of the determined behavior feature and the determined cluster; and
detecting means for detecting the content property on basis of the determined confidence level of the content property presence.

14. An image processing apparatus comprising:
receiving means for receiving a data stream representing a sequence of video images;
a unit for detecting a content property in the sequence of video images on basis of low-level features as claimed in claim 13; and
an image processing unit being controlled by the unit for detecting a content property on basis of the content property.

15. An image processing apparatus as claimed in claim 13, wherein the image processing unit comprises a storage device.

16. An image processing apparatus as claimed in claim 13, wherein the image processing unit comprises a video image compression device.

17. An audio processing apparatus comprising:
receiving means for receiving a data stream representing audio;
a unit for detecting a content property in the audio on basis of low-level features as claimed in claim 13; and
an audio processing unit being controlled by the unit for detecting a content property, on basis of the content property.
